(19) United States
(12) Patent Application Publication
(10) Pub. No.: US 2012/0093980 A1
(43) Pub. Date: Apr. 19, 2012

(54) Stabilizer System For Protein Beverages

(75) Inventors: Ricardo Pereyra, White Plains, NY (US); William Mutilangi, Peekshill, NY (US)

(73) Assignee: PEPSICO, INC., Purchase, NY (US)

(21) Appl. No.: 12/903,503

(22) Filed: Oct. 13, 2010

(51) Int. Cl. A23C 9/152; A23C 9/158

(52) U.S. Cl. 426/72; 426/583

(57) ABSTRACT

A stabilized protein beverage has a protein source which is whey protein concentrate or isolate, milk protein concentrate or isolate, soy protein, caseinate, or a combination thereof. The beverage has a stabilizer system which includes a blend of carboxymethylcellulose and gellan gum.

### BACKGROUND

New and improved beverage formulations are desirable to meet changing market demands, particularly beverages having alternative nutritional characteristics, including, e.g., protein and calorie content. Energy drinks are an increasingly popular class of beverages that offer sustained energy by providing a combination of protein, complex carbohydrates, and fiber.

The development of new beverage formulations, for example those employing alternative sweeteners, flavorants, flavor enhancing agents, protein, and the like, presents challenges such as providing stability of the beverages containing such ingredients, particularly with respect to energy drinks such as protein beverages.

A number of materials have been employed to stabilize energy drinks, including hydrocolloids such as gum arabic, xanthan gum, pectin, starch and modified starch, and carboxymethylcellulose. In general, relatively large quantities of these materials are needed to achieve an effective degree of stabilization. Such materials present in such large quantities may adversely affect beverage characteristics such as flavor and feel. In addition, certain beverage stabilizing materials, such as xanthan gum, are prone to react with other beverage components, such as milk proteins or beer proteins, affecting beverage flavor and/or stabilizer efficacy.

It is particularly challenging to stabilize protein beverages in which the protein source is whey protein concentrate or isolate, milk protein concentrate or isolate, soy protein, or caseinate. Many stabilizer systems which are effective for stabilizing beverages containing milk protein, for example, are largely or entirely ineffective for stabilizing protein beverages in which the protein source is whey protein concentrate or isolate, milk protein concentrate or isolate, soy protein, or caseinate.

There remains a need for stabilizer systems and beverage formulations which can meet the combination of objectives including nutritional, flavor, stability, shelf life, and other objectives, particularly with respect to protein beverages in which the protein source is whey protein concentrate or isolate, milk protein concentrate or isolate, soy protein, or caseinate.

### SUMMARY

In accordance with one aspect, a protein beverage comprises a stabilizer system containing a blend of carboxymethylcellulose and gellan gum. The protein beverage has a protein source which is whey protein concentrate or isolate, milk protein concentrate or isolate, soy protein, caseinate, or a combination thereof. The stabilizer system provides excellent protein and beverage stability under high and low acid conditions, and provides a more appealing color to the protein beverages. The stabilizer system also is much more cost effective than previous systems employing pectin.

It will be appreciated by those skilled in the art, given the benefit of the following description of certain exemplary embodiments of the beverage products disclosed here, that at least certain embodiments of the invention have improved or alternative formulations suitable to provide desirable taste profiles, nutritional characteristics, etc. These and other aspects, features and advantages of the invention or of certain embodiments of the invention will be further understood by those skilled in the art from the following description of exemplary embodiments.

### DETAILED DESCRIPTION

Aspects of the invention are directed to a stabilizer system for a protein beverage. The stabilizer system comprises a blend of carboxymethylcellulose and gellan gum. The protein drink has a protein source which is whey protein concentrate or isolate, milk protein concentrate or isolate, soy protein, caseinate, or a combination thereof

The stabilizer system also provides a suitable body and mouthfeel of the beverage. For example, the stabilized beverage as described herein may have a smooth and creamy, or thick and textured consistency.

Gellan gum is a heteropolysaccharide prepared by fermentation of Pseudomonas elodea ATCC 31461. Gellan gum is commercially available, for example, from Merck & Co., Inc., under various names, including KELCOGEL, KELCOGEL PC, and KELCOGEL F. Examples of processes for preparing gellan gum are described in U.S. Pat. Nos. 4,326,052 and 4,326,053. KELCOGEL PC, for example, consists of 80% KELCOGEL F fine mesh gellan gum and 20% fine mesh sodium citrate. The amount of gellan gum usually ranges from about 0.01 to about 0.1% by weight, often from about 0.02 to about 0.05% by weight, based on the total weight of the beverage.

Carboxymethylcellulose is a cellulose derivative which is commercially available and has been used in a variety of applications including drilling muds, as a soil-suspending agent in detergents, in resin emulsion paints, adhesives, printing inks, textile sizes, and as a food stabilizer. An example of a commercial carboxymethylcellulose product is AQUALON® CMC-7HF, available from Hercules. The amount of carboxymethylcellulose usually ranges from about 0.01 to about 1% by weight, often from about 0.1 to about 0.8% by weight, and usually from about 0.2 to about 0.6% by weight, based on the total weight of the beverage.

In some aspects, the stabilizer system consists only of carboxymethylcellulose and gellan gum as described herein. In other embodiments, the stabilizer system may include other potentially beneficial components, non-limiting examples of which include hydrocolloids, xanthan gum, pectin, starch, and modified starch. The amount of such other components, if any, should be less than amount(s) which deleteriously affect the desired beverage characteristics as described herein. The overall stabilizer system usually is present in the beverage in an amount from about 0.01 to about 2%, often from about 0.02 to about 1%, and more often from about 0.1 to about 0.8% by weight, based on total weight of the beverage.

The stabilizer system components may be combined together or added separately to the beverage, for example under high shear mixing. Generally, the temperature of mixing is about 125 to about 135 ° F. Mixing can be accomplished, for example, using a Silverson L4RT (England) high shear mixer, at speed #8 for 5 minutes.

The stabilizer blend is particularly useful in protein-containing beverages in which the protein source is whey protein concentrate or isolate, milk protein concentrate or isolate, soy protein, or caseinate. The term “protein concentrate” refers to a protein-rich powder prepared by treating a protein source, e.g., milk or whey protein, in an ultra-filtration process which removes the liquid and smaller molecules. The term “protein isolate” as used herein refers to a product resulting from the extraction, subsequent concentration, and purification of proteinaceous material from a proteinaceous source such as a whey or milk protein. Typically, the protein isolate has a protein content of about 90 to about 98% by weight on a dry weight basis.

The use of the stabilizer blend provides a smooth, thick texture and stability to a variety of shelf-stable beverages, including dairy based energy drinks In addition, the blend successfully suspends solids throughout the beverage and prevents sedimentation and/or separation.

In some aspects of the invention, the beverage is protein or energy drink such as a smoothie-type beverage containing protein and/or fiber and flavored with flavors such as such as vanilla or chocolate.

Additional beverage ingredients can be selected from sweeteners, vitamins, fiber, milk, milk solids, soy milk, (albumins are a whey protein fraction), coffee, coffee solids, vegetable juice, vegetable puree, tea, tea solids, preservatives, buffers, colors, flavors, and combinations thereof. Fruit juice or fruit puree may be added in small amounts such that the acidity of the fruit addition does not effect the final stable composition.

As used herein, “beverage” refers to, without limitation, smoothie beverages, protein drinks, shakes, vegetable juice drinks, dairy-based drinks, coffee and tea-based drinks and any other beverage to which a degree of thickness and/or stability is desirable; “beverage” also refers to any drink which contains suspended solids. As used herein, “smoothie” and “smoothie beverage” are used interchangeably and refer to beverages with a characteristic thickness which can be attributed to the presence therein of ingredients such as sweeteners, acids, vitamins, fiber, fruit juice, fruit puree, milk, milk solids, milk proteins, soy milk, soy proteins, coffee, coffee solids, vegetable juice, vegetable puree, tea, tea solids, preservatives, buffers, colors, flavors, and combinations thereof. Smoothie beverages may be fruit-based, juice-based, dairy-based, coffee-based, soy-based, vegetable-based, tea-based or a combination thereof

As used herein, “stable” refers to the absence of sedimentation, phase separation, striation, etc., preferably for a period of at least 6 months. As used herein, “shelf-stable” refers to an inability to support the growth of microorganisms at typical distribution temperatures over the course of shelf life, preferably over the course of at least 6 months; one of ordinary skill in this art will readily appreciate that the stable beverages of the present invention may not be shelf-stable in extreme or abusive environmental conditions.

The beverage products disclosed here optionally contain additional ingredients, including, for example, flavorings such as natural fruit flavors, botanical flavors, other flavors, and mixtures thereof. As used here, the term “fruit flavor” refers generally to those flavors derived from the edible reproductive part of a seed plant. Included are both those wherein a sweet pulp is associated with the seed, e.g., banana, tomato, cranberry and the like, and those having a small, fleshy berry. The term berry also is used here to include aggregate fruits, i.e., not “true” berries, but fruit commonly accepted as such. Examples of suitable fruit or berry sources include whole berries or portions thereof, berry juice, berry juice concentrates, berry purees and blends thereof, dried berry powders, dried berry juice powders, and the like.

Exemplary fruit flavors include the citrus flavors, e.g., orange, lemon, lime, tangerine, mandarin orange, tangelo, pomelo, and grapefruit, and such flavors as apple, grape, cherry, and pineapple flavors and the like, and mixtures thereof. In certain exemplary embodiments the beverage concentrates and beverages comprise a fruit flavor component, e.g., a juice concentrate or juice. As used here, the term “botanical flavor” refers to flavors derived from parts of a plant other than the fruit. As such, botanical flavors can include those flavors derived from essential oils and extracts of nuts, bark, roots and leaves. Examples of such flavors include cola flavors, tea flavors, coffee flavors and the like, and mixtures thereof. The flavor component can further comprise a blend of various of the above-mentioned flavors. The particular amount of the flavor component useful for imparting flavor characteristics to the beverages of the present invention will depend upon the flavor(s) selected, the flavor impression desired, and the form of the flavor component. Those skilled in the art, given the benefit of this disclosure, will be readily able to determine the amount of any particular flavor component(s) used to achieve the desired flavor impression.

Juices suitable for use in at least certain exemplary embodiments of the beverage products disclosed here include, e.g., fruit, vegetable and berry juices. Juices can be employed in the present invention in the form of a concentrate, puree, single-strength juice, or other suitable forms. The term “juice” as used here includes single-strength fruit, berry, or vegetable juice, as well as concentrates, purees, milks, and other forms. Multiple different fruit, vegetable and/or berry juices can be combined, optionally along with other flavorings, to generate a beverage having the desired flavor. Examples of suitable juice sources include plum, prune, date, currant, fig, grape, raisin, cranberry, pineapple, peach, banana, apple, pear, guava, apricot, saskatoon berry, blueberry, plains berry, prairie berry, mulberry, elderberry, Barbados cherry (acerola cherry), choke cherry, date, coconut, olive, raspberry, strawberry, huckleberry, loganberry, currant, dewberry, boysenberry, kiwi, cherry, blackberry, quince, buckthorn, passion fruit, sloe, rowan, gooseberry, pomegranate, persimmon, mango, rhubarb, papaya, litchi, lemon, orange, lime, tangerine, mandarin orange, tangelo, pomelo, and grapefruit etc. Numerous additional and alternative juices suitable for use in at least certain exemplary embodiments will be apparent to those skilled in the art given the benefit of this disclosure. In the beverages of the present invention employing juice, juice may be used, for example, at a level of at least about 0.1% by weight of the beverage. In certain exemplary embodiments juice is employed at a level of from about 0.1% to about 3.0% by weight of the beverage. Typically, juice can be used, if at all, in an amount of from about 1% to about 2% by weight.

Certain such juices which are lighter in color can be included in the formulation of certain exemplary embodiments to adjust the flavor and/or increase the juice content of the beverage without darkening the beverage color. Examples of such juices include apple, pear, pineapple, peach, lemon, lime, orange, apricot, grapefruit, tangerine, rhubarb, cassis, quince, passion fruit, papaya, mango, guava, litchi, kiwi, mandarin, coconut, and banana. Deflavored and decolored juices can be employed if desired.

Other flavorings suitable for use in at least certain exemplary embodiments of the beverage products disclosed here include, e.g., spice flavorings, such as cassia, clove, cinnamon, pepper, ginger, vanilla spice flavorings, cardamom, coriander, root beer, sassafras, ginseng, and others. Numerous additional and alternative flavorings suitable for use in at least certain exemplary embodiments will be apparent to those skilled in the art given the benefit of this disclosure. Flavorings can be in the form of an extract, oleoresin, juice concentrate, bottler's base, or other forms known in the art. In at least certain exemplary embodiments, such spice or other flavors complement that of a juice or juice combination.

The beverage products disclosed here optionally may contain other additional ingredients, including, generally, any of those typically found in beverage formulations. These additional ingredients, for example, can typically be added to a stabilized beverage formulation. Examples of such additional ingredients include, but are not limited to, caramel and other coloring agents or dyes, antifoaming agents, gums, emulsifiers, tea solids, cloud components, and mineral and non-mineral nutritional supplements. Examples of non-mineral nutritional supplement ingredients are known to those of ordinary skill in the art and include, for example, antioxidants and vitamins, including Vitamins A, D, E (tocopherol), C (sodium ascorbate), B (thiamine), B₂ (riboflavin), B₆, B₁₂, and K, niacin, folic acid, biotin, and combinations thereof. The optional non-mineral nutritional supplements are typically present in amounts generally accepted under good manufacturing practices. Exemplary amounts are between about 1% and about 100% RDV, where such RDV are established. In certain exemplary embodiments the non-mineral nutritional supplement ingredient(s) are present in an amount of from about 5% to about 20% RDV, where established.

Suitable sweeteners may be used including artificial and natural sweeteners, nutritive and non-nutritive sweeteners.

In accordance with another aspect, a method of preparing a beverage product is provided which comprises including in the beverage product a stabilizer system comprising a blend of carboxymethylcellulose and gellan gum. For example, water is heated to about 120° F. to about 140° F., for instance about 130° F. A dry blend of the protein component(s) and sugar are slowly added to water while stirring. The solution is then heated to about 120° F. to about 140° F., for instance about 130° F. Dry ingredients are added to the mixture, e.g., after reaching about 120° F.

Carboxymethylcellulose and gellan gum may be dispersed in water using a high shear mixer and then added to the protein mixture. The mixture may be allowed to sit for about 15 minutes to allow for complete hydration. The solids are measured and adjusted to target level by adding water. Flavors and colors then may be added. The stabilizer may be blended by adding 1 part stabilizer blend to 20 parts of water and high shearing for 5 minutes at high speed.

Generally, homogenization is not needed, although in some cases the beverage may be homogenized, e.g., if components are not completely mixed or similar in particle size. Homogenization may be performed, e.g., by high pressure treatment at 1000 to 5000 pounds per square inch, utilizing a valve-type Rannie or Gaulin homogenizer.

Generally, the finished beverage is aseptically manufactured and shelf-stable at room temperature until opened when ready for use.

### EXAMPLES

The following are examples are provided for illustrative purposes and should not be regarded as limiting the scope of the invention.

### Examples 1-20

Stabilized protein beverages are formulated by combining water with protein component(s) of whey protein concentrate (WPC), whey protein isolate (WPI), milk protein concentrate (MPC), milk protein isolate (MPI), soy protein (SP), and/or caseinate (C); and a stabilizer containing a blend of carboxymethylcellulose (CMC) and gellan gum (GG), in the amounts shown in Table 1 below. Flavors and other beverage components not listed in Table 1 also may be added in appropriate amounts. All amounts are given in percent by weight, based on the total weight of the beverage composition. The resulting beverages are stable for a period of at least six months.

TABLE 1

| Example | WPC | WPI | MPC | MPI | SP | C | CMC | GG |
|---|---|---|---|---|---|---|---|---|
| 1 | 2.5 | — | — | — | — | — | 0.4 | 0.025 |
| 2 | — | 2.0 | — | — | — | — | 0.375 | 0.02 |
| 3 | — | — | 0.5 | — | — | — | 0.325 | 0.025 |
| 4 | — | — | — | 1.5 | — | — | 0.3 | 0.02 |
| 5 | — | — | — | — | 1.75 | — | 0.425 | 0.025 |
| 6 | — | — | — | — | — | 2.0 | 0.425 | 0.035 |
| 7 | 0.75 | — | 0.5 | — | — | — | 0.375 | 0.03 |
| 8 | — | 1.25 | — | 0.5 | — | — | 0.45 | 0.03 |
| 9 | — | 8.0 | — | — | — | — | 0.4 | 0.025 |
| 10 | — | — | — | — | 2.0 | — | 0.4 | 0.025 |
| 11 | — | 8.0 | — | — | 2.0 | — | 0.4 | 0.025 |
| 12 | 1.5 | — | — | — | — | — | 0.35 | 0.02 |
| 13 | — | 0.75 | — | — | — | — | 0.275 | 0.02 |
| 14 | — | — | 1.5 | — | — | — | 0.425 | 0.03 |
| 15 | — | — | — | 2.0 | — | — | 0.375 | 0.025 |
| 16 | — | — | — | — | 0.75 | — | 0.35 | 0.02 |
| 17 | — | — | — | — | — | 0.8 | 0.325 | 0.03 |
| 18 | — | — | 0.75 | 0.5 | — | — | 0.4 | 0.025 |
| 19 | — | — | — | 1.0 | — | 0.5 | 0.35 | 0.02 |
| 20 | 0.5 | — | — | 0.75 | — | — | 0.325 | 0.025 |

Generally, energy drinks may contain one or more of the following: filtered water, skim milk, sugar, milk protein concentrate, sucromalt, cream, maltodextrin, natural flavor, dextrose, cellulose gel, salt, guar gum, lambda-carraggenan, sodium ascorbate, D-ribose, vitamin E acetate, soy lecithin, colors such as lycopene and/or annatto, vitamin a palmitate, niacinamide, citric acid, vitamin D3, pyridoxine hydrochloride, (vitamin B6), cyanocobalamin (vitamin B12). Fruit juices and purees also may be included such as mango puree.

Given the benefit of the above disclosure and description of exemplary embodiments, it will be apparent to those skilled in the art that numerous alternative and different embodiments are possible in keeping with the general principles of the invention disclosed here. Those skilled in this art will recognize that all such various modifications and alternative embodiments are within the true scope and spirit of the invention. The appended claims are intended to cover all such modifications and alternative embodiments. It should be understood that the use of a singular indefinite or definite article (e.g., “a,” “an,” “the,” etc.) in this disclosure and in the following claims should be construed as meaning “at least one” unless otherwise clear from context. Likewise, the term “comprising” is open-ended and does not exclude additional items, features, components, steps, etc.

What is claimed is:

1. A stabilized protein beverage having a protein source selected from the group consisting of whey protein concentrate, whey protein isolate, milk protein concentrate, milk protein isolate, soy protein, caseinate, and a combination thereof, the beverage comprising a stabilizer system comprising a blend of carboxymethylcellulose and gellan gum.

2. The beverage of claim 1, wherein gellan gum is present in an amount of from about 0.01 to about 0.1% by weight, based on the total weight of the beverage.

3. The beverage of claim 2, wherein gellan gum is present in an amount of from about 0.02 to about 0.05% by weight, based on the total weight of the beverage.

4. The beverage of claim 1, wherein carboxymethylcellulose is present in an amount from about 0.01 to about 1% by weight, based on the total weight of the beverage.

5. The beverage of claim 4, wherein carboxymethylcellulose is present in an amount from about 0.1 to about 0.8% by weight, based on the total weight of the beverage.

6. The beverage of claim 5, wherein carboxymethylcellulose is present in an amount from about 0.2 to about 0.6% by weight, based on the total weight of the beverage.

7. The beverage of claim 1 wherein the stabilizer system is present in an amount ranging from about 0.1% to about 0.8% by weight based on total weight of the beverage.

8. The beverage of claim 1 further comprising at least one ingredient selected from the group consisting of sweeteners, proteins, fiber, milk, milk solids, soy milk, albumins, vitamins, preservatives, buffers, colors, and flavors.

9. The beverage of claim 1 wherein the beverage is a dairy-based drink.

10. The beverage of claim 1 wherein the beverage is an energy drink.

11. The beverage of claim 1 wherein the protein source is selected from the group consisting of whey protein concentrate, whey protein isolate, milk protein concentrate, milk protein isolate, and combinations thereof

12. The beverage of claim 1 wherein the protein source is selected from the group consisting of whey protein concentrate and whey protein isolate.

13. The beverage of claim 1 wherein the protein source is selected from the group consisting of milk protein concentrate and milk protein isolate.

14. A stabilized protein beverage having a protein source selected from the group consisting of whey protein concentrate, whey protein isolate, milk protein concentrate, milk protein isolate, and a combination thereof, the beverage comprising a stabilizer system comprising from about 0.1 to about 0.8% by weight carboxymethylcellulose and from about 0.02 to about 0.05% by weight gellan gum, based on the total weight of the beverage.
